(19) United States
(12) Patent Application Publication
(10) Pub. No.: US 2006/0162209 A1
(43) Pub. Date: Jul. 27, 2006

(54) Holder for a storage medium

(75) Inventor: Timothy J. Philpot, Havant (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/524,378

(22) PCT Filed: Jul. 29, 2003
(86) PCT No.: PCT/IB03/03353

§ 371 Date: Feb. 10, 2005

(30) Foreign Application Priority Data
Aug. 14, 2002 (GB) 0218858.9

(51) Int. Cl. G09F 3/18

(52) U.S. Cl. 40/642.02

(57) ABSTRACT

A holder (20) either to which a computer readable storage medium (10) can be detachably attached or in which a computer readable storage medium can be encased is disclosed, the holder having a planar shape and a size corresponding to that of a standard credit card and/or standard business card. In particular, the holder may have a substantially rectangular shape with planar dimensions of 85 mm to 86 mm by 54 to 55 mm.

This invention relates to a holder for a computer readable storage medium.

Royal Philips Electronics of the Netherlands (hereafter “Philips”) is presently developing miniature optical disc drives using blue laser technology which can store up to 1 Gigabyte of data on a single-sided removable, optical disc of just 30 mm in diameter. This work is further described in Philips' press release entitled “Philips Develops Technology for Small Form Factor Optical Storage” dated Jun. 18, 2002 and available from Philips's website at www.newscenter.philips.com.

With their integral housing, these “small form factor” optical discs have external dimensions of approximately 30 mm×40 mm×2.5 mm and are ideal for storage applications which have size constraints such as in digital cameras, mobile phones, PDAs etc. However, when removed from the disc drive, these discs are sufficiently small as to present a handling problem. Such discs could of course be stored using miniaturised versions of the jewel case, the original case designed by Philips for Compact Discs (CDs), or indeed a miniaturised version one of the many variations on the jewel case that have been developed over recent years.

European patent application, publication number EP1103976A1 and PCT patent application, publication number WO01/81206A1 both disclose a holder to which a computer readable storage medium can be detachably attached. In particular, WO01/81206A1 contemplates a holder for a digital business card being a CD which has been cut down or re-sized as to approximate the dimensions of a contemporary European business card.

It is an object of the present invention to provide a novel holder, either to which a computer readable storage medium can be detachably attached or in which a computer readable storage medium can be encased

In accordance with the present invention, such a holder provided having a planar shape, ideally with a thickness of less than 5 mm, and a size corresponding to that of a standard credit card and/or standard business card.

Such a holder would enable a small, computer readable storage medium to be stored in a wallet and, in particular, a compartment specifically provided for the safe storage of a credit and/or business card in a wallet as already exists.

At least in the United Kingdom, the standard credit card and/or standard business card has a substantially rectangular shape with planar dimensions of 85 mm to 86 mm by 54 to 55 mm although, of course, credit cards which are commonly made from rigid plastic often have rounded edges.

Where a substantially planar shaped, computer readable storage medium is detachably attached to or encased in the holder, the planar area of the holder may be at least 75%, 100% or even 200% greater than the planar area of the computer readable storage medium. Notwithstanding further miniaturisation of computer readable storage media, the prevalence of the credit card and/or the business card means that it will be desirable to have a holder which retains its planar size and shape.

Furthermore, it is conceivable that where a computer readable storage medium is small enough, a holder may be provided whereby at least two such media can be detachably attached.

The present invention will now be described, by way of example only, with reference to the accompanying drawings in which:

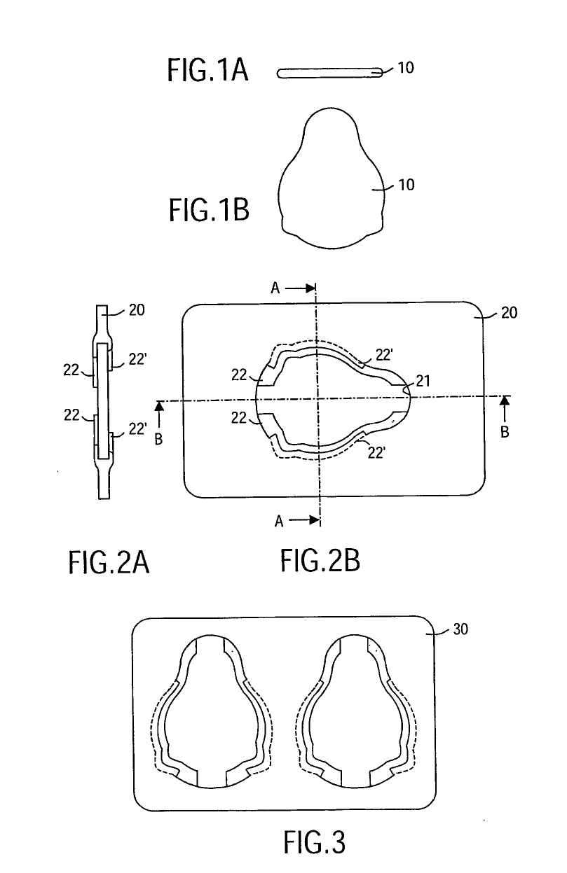

FIGS. 1A and 1B respectively show in plan and elevation views, the outside of an aforementioned “small form factor” disc with integral casing;

FIGS. 2A and 2B respectively show a section A-A and an elevation view of a holder according to the present invention to which an optical disc casing of the type shown in FIGS. 1A and 1B can be detachably attached; and

FIG. 3 shows an alternative holder according to the present invention.

FIGS. 1A and 1B show a “small form factor” optical disc 10 with integral casing of the type currently being developed by Philips and having dimensions of approximately 40 mm×30 mm×2 mm.

A holder 20 for storing a disc 10 of the type shown in FIGS. 1A and 1B is shown in FIGS. 2A and 2B. The holder is substantially planar is shape and has planar dimensions of 86 mm×55 mm, corresponding to the standard size for a European business card. The holder has a aperture 21 corresponding to the shape of the disc and lips 22, 22′ either side of the aperture suitable for restraining the disc in the aperture.

The holder 20 is plastic and mildly deformable so as to enable the disc 10 to the pressed in to and popped out of the aperture from one side of the holder. The absence of lips along axis B-B which passes though the centre of the card, parallel with the longest planar dimension encourages the card to deform along this axis under appropriate stress to facilitate attaching and detecting a disc to the holder. The lips may themselves be mildly deformable.

FIG. 3 shows an alternative holder according to the present invention employing the same fastening arrangement as the holder shown in FIGS. 2A and 2B but able to detachably attach discs of the type shown in FIGS. 1A and 1B.

Whilst the aforementioned holders expose both side of the disc to the environment, it would of course be possible to fully encase a disc of the type shown in FIGS. 1A and 1B in a jewel type case or any other type of case having a size corresponding to that of a standard credit card and/or standard business card.

Also, whilst the above holder is described in the context of an optical disc storage medium, it will be appreciated that the invention is equally applicable to other types of storage media including magnetic disc storage and solid state storage.

1. A holder (20) either to which a computer readable storage medium (10) can be detachably attached or in which a computer readable storage medium can be encased, the holder having a planar shape and a size corresponding to that of a standard credit card and/or standard business card.

2. A holder according to claim 1 having a substantially rectangular shape with planar dimensions of 85 mm to 86 mm by 54 to 55 mm.

3. A holder according to claim 1 having a thickness of less than 5 mm.

4. A holder according to claim 1 to which a substantially planar shaped, computer readable storage medium can be detachably attached, wherein the planar area of the holder is at least 75% greater than the planar area of the computer readable storage medium

5. A holder according to claim 4 wherein the planar area of the holder is at least 100% greater than the planar area of the computer readable storage medium.

6. A holder according any preceding claim to which at least two computer readable storage media can be detachably attached
